(19) United States
(12) Patent Application Publication
(10) Pub. No.: US 2008/0280960 A1
(43) Pub. Date: Nov. 13, 2008

(54) Waterbased Bit/Tmad Formulations

(76) Inventors: Hermann Uhr, Leverkusen (DE); Peter Wachtler, Krefeld (DE)

Correspondence Address: LANXESS CORPORATION, 111 RIDC PARK WEST DRIVE, PITTSBURGH, PA, 15275-1112, US

(21) Appl. No.: 11/886,118

(22) PCT Filed: Mar. 15, 2006
(86) PCT No.: PCT/EP2006/002395

§ 371 Date: Sep. 11, 2007

(30) Foreign Application Priority Data
Mar. 26, 2005 (DE) 10 2005 013 956.6

(51) Int. Cl. A01N 43/78; A01P 1/00

(52) U.S. Cl. 514/367

(57) ABSTRACT

Aqueous formulations having a pH of >10 of 1,2-benzoisothiazolin-3-one (BIT) and/or its alkali metal salts and tetramethylolacetylenediurea (TMAD) are outstandingly suitable for protecting industrial materials and products from infection and destruction by microorganisms.

The invention relates to aqueous formulations having a pH of >10 of 1,2-benzoisothiazolin-3-one (BIT) and/or its alkali metal salts and tetramethylolacetylenediurea (TMAD), to processes for preparing these formulations and to their use for protecting industrial materials and products from infection and destruction by microorganisms.

1,2-Benzisothiazolin-3-one (BIT) and its sodium, potassium and lithium salts are active ingredients which have been used in industry for some time for the preparation of microbicidally active formulations. 1,2-Benzoisothiazolin-3-one (BIT) features good chemical and thermal stability and in principle has broad antimicrobial action, for example against bacteria, fungi and yeasts. However, the efficacy against particular types of bacteria is not always satisfactory and the observed speed of action in some cases is insufficient to prevent microbiologically induced material damage.

A further disadvantage of 1,2-benzoisothiazolin-3-one (BIT) is its poor water solubility. For this reason, BIT is generally formulated in the form of alkali metal salts at high pH values. In order to ensure sufficient solubility, in spite of the high pH values, cosolvents must, though, be used in the form of water-miscible solvents, for example propylene glycol (cf. U.S. Pat. No. 4,188,376; WO 94/16564).

To avoid the abovementioned gaps in effectiveness and the slow onset of action, BIT is used in practice in combination with other active ingredients. For example, the desired properties can be achieved by using BIT in combination with formaldehyde or formaldehyde depot substances. To avoid toxicologically undesired effects caused by free formaldehyde, chemically bound formaldehyde, for example in the form of N-formals (N-hydroxymethyl compounds), can be used as a mixing partner. For example, various mixtures/synergies of benzoisothiazolinone with N-formals have been described, for example with 1,3-bis(hydroxymethyl)-5,5-dimethylhydantoin (cf. EP-A 1225803) or tetramethylolacetylenediurea (cf. EP-A 0060471; EP-A 1249166; DE-A 10251915). A disadvantage of these known synergistic mixtures of 1,2-benzoisothiazolin-3-one (BIT) and an N-formal is that it has not been possible to date, without addition of solvents, to bring them into a supply form/formulation which firstly enables simple application (for example pumpable solution) and secondly is also storable for a prolonged period without loss of the chemical, physical and biological properties. For ecological and toxicological reasons, however, it is desirable to use as far as possible no organic substances, for example solvents and cosolvents, but in particular no such additives comprising VOCs (volatile organic compounds), as well as the active ingredients in the formulations. The type of formulation must not result in any change in the content of free formaldehyde in the course of storage and should not exceed 1% in total.

Formulations with the above requirements are difficult to realise because opposing demands are made here. Firstly, in order to achieve very good solubility of 1,2-benzoisothiazolin-3-one (BIT) in water, a very high pH has to be established; secondly, mixtures of 1,2-benzoisothiazolin-3-one (BIT) and its alkali metal salts and N-methylol compounds are generally unstable under these conditions, and a decrease in the originally used amount of 1,2-benzoisothiazolin-3-one is observed in the course of storage.

Considering, for example, a mixture of BIT and DMDMH (1,3-bis(hydroxymethyl)-5,5-dimethylimidazolidine-2,4-dione), even establishment of high pH values only allows a clear solution to be obtained through use of cosolvents, and the formulation itself is not storable without degradation over a prolonged period even at relatively low pH values.

It was therefore an object of the present invention to provide formulations of BIT and a formaldehyde eliminator which are preferably solvent-free and in which the content of free formaldehyde does not change even in the course of storage.

It has now been found that, surprisingly, aqueous alkaline formulations having a pH of >10 comprising 1,2-benzoisothiazolin-3-one (BIT) and/or its alkali metal salts and tetramethylolacetylenediurea (TMAD) which have good long-term stability can be prepared without adding solvents and/or cosolvents.

The present invention provides aqueous alkaline formulations having a pH of >10, comprising 1,2-benzoisothiazolin-3-one (BIT) and/or its alkali metal salts and tetramethylolacetylenediurea (TMAD).

The inventive formulations comprise 1,2-benzoisothiazolin-3-one (BIT) and/or its sodium, potassium or lithium salts or mixtures thereof. The amounts of 1,2-benzoisothiazolin-3-one (BIT) and/or its sodium, potassium or lithium salts or mixtures thereof and tetramethylolacetylenediurea (TMAD) in the inventive formulations may vary over a wide range. In general, the ratio of 1,2-benzoisothiazolin-3-one (BIT) and/or its sodium, potassium or lithium salts or mixtures thereof to tetramethylolacetylenediurea (TMAD) in the inventive formulations is within the weight ratio of 9:1 to 1:9, preferably of 5:1 to 1:7, more preferably of 1:1 to 1:7.

The inventive formulations comprise the active ingredients 1,2-benzoisothiazolin-3-one (BIT) and/or its sodium, potassium or lithium salts or mixtures thereof and tetramethylolacetylenediurea (TMAD), calculated as the sum of the two components, in a concentration of 5 to 80% by weight, preferably 10 to 60% by weight.

The inventive formulations comprise 1,2-benzoisothiazolin-3-one (BIT) and/or its sodium, potassium or lithium metal salts or mixtures thereof. The amounts of BIT and/or its alkali metal salts in the formulation are generally 0.5 to 30% by weight, preferably 1 to 25% by weight, in particular 2 to 20% by weight, based in each case on the total weight of the formulation. The inventive formulations contain TMAD generally in an amount of 3 to 70% by weight, preferably of 5 to 60% by weight and in particular of 10 to 50% by weight, based on the total weight of the formulation.

The inventive formulations generally have a pH of >10. The pH is preferably 10 to 14, more preferably 10-13 and most preferably 10-12.

The inventive formulations feature excellent long-term stability. In this context, neither significant active ingredient degradation nor cloudiness, precipitation, relatively large pH shifts are observed. It has also been found that the proportion of free formaldehyde in the formulation is very low and is generally <1%, in particular <0.5%, and also does not change significantly in the course of storage.

The inventive formulations are preferably free of solvents and cosolvents. The inventive formulations may optionally contain cosolvents in small amounts of 0 to 5% by weight, preferably of 0 to 3% by weight and in particular of 0 to 1% by weight.

The inventive formulations can be prepared by
a) dissolving BIT and/or its sodium salt and/or its potassium salt and/or its lithium salt in water, optionally with addition of sodium hydroxide, potassium hydroxide, lithium hydroxide or mixtures thereof, and mixing this solution
b) with a solution of tetramethyloldiurea (TMAD) in water, and
c) optionally with a cosolvent,
   and optionally adjusting the pH of the overall formulation to a value of >10 by adding sodium hydroxide, potassium hydroxide, lithium hydroxide or mixtures thereof.

The alkaline 1,2-benzoisothiazolin-3-one (BIT) solution used to prepare the inventive formulations can be prepared either by dissolving the sodium, potassium or lithium salt of 1,2-benzoisothiazolin-3-one in water and optionally adding NaOH, KOH or LiOH to establish higher pH values, or by starting from 1,2-benzoisothiazolin-3-one and preparing the salts by adding NaOH, KOH or LiOH or mixtures thereof in water.

The solution of tetramethylolacetylenediurea (TMAD) used to prepare the inventive formulations can be prepared either analogously to the method described in EP-A 0060471, or commercial solutions of tetramethylolacetylenediurea (TMAD), for example Acticide® F(N) or Protectol® TD, are used.

The cosolvents to be used optionally are generally water-miscible solvents, for example:

alcohols such as butanol, glycerol, glycols and their ethers and esters, ketones such as acetone, methyl ethyl ketone, methyl isobutyl ketone or cyclohexanone, and strongly polar solvents such as dimethylformamide, dimethyl sulphoxide, N-methylpyrrolidone.

The amount of cosolvents is generally below 5% by weight; the amount is preferably less than 3% by weight, more preferably less than 1% by weight.

The inventive formulations are suitable for protecting industrial materials and products from infection and destruction by microorganisms.

The inventive formulations can preferably be used to preserve functional liquids and aqueous industrial products which are prone to infection by microorganisms.

By way of example but without limitation, the following functional liquids and aqueous industrial products which can preferably be protected with the inventive formulations are mentioned:
paints, colours, plasters and other coating compositions
starch solutions and slurries or other products prepared on the basis of starch, for example printing thickeners
slurries of other raw materials, such as chromatic pigments (e.g. iron oxide pigments, carbon black pigments, titanium dioxide pigments) or slurries of fillers and coating pigments such as kaolin, calcium carbonate or talc
construction chemical products such as concrete additives, for example based on molasses, lignosulphonate or polyacrylates, bitumen emulsions or sealants
sizes or adhesives based on the known animal, vegetable or synthetic raw materials
polymer dispersions based, for example, on polyacrylate, polystyrene-acrylate, styrene-butadiene, polyvinyl acetate, inter alia
detergents and cleaning compositions for industrial and domestic use
mineral oils and mineral oil products (for example diesel fuels)
cooling lubricants for metal processing, based on mineral oil-containing, semisynthetic or synthetic concentrates
auxiliaries for the leather, textile or photochemical industry
precursors and intermediates of the chemical industry, for example in dye production and storage
solvent-borne or water-borne inks
wax and clay emulsions.

The inventive formulations are used in material protection for the protection of industrial materials, especially for the protection of aqueous functional liquids; they are effective against bacteria, mildew, yeasts and against slime organisms. By way of example but without limitation, the following microorganisms are mentioned:

Alternaria such as Alternaria tenuis, Aspergillus such as Aspergillus niger, Chaetomium such as Chaetomium globosum, Fusarium such as Fusarium solani, Lentinus such as Lentinus tigrinus, Penicillium such as Penicillium glaucum;

Alcaligenes such as Alcaligenes faecalis, Bacillus such as Bacillus subtilis, Escherichia such as Escherichia coli, Pseudomonas such as Pseudomonas aeruginosa or Pseudomonas fluorescens, Staphylococcus such as Staphylococcus aureus;

Candida such as Candida albicans, Geotrichum such as Geotrichum candidum, Rhodotorula such as Rhodotorula rubra.

The inventive formulations may additionally comprise one or more further active biocidal ingredients. Mixing partners include the compounds
Benzyl hemiformal
Bronopol
Chloromethylisothiazolinone
p-Chloro-m-cresol
Dimethylolurea
4,5-Dichloro-2-n-octylisothiazolin-3-one
1,2-Dibromo-2,4-dicyanobutane
2,2-Dibromo-3-nitrilopropionamide
Ethylene glycol hemiformal
Ethylene glycol bis-hemiformal
Glutaraldehyde
Iodopropargyl butylcarbamate
N-Methylolurea
2-n-Octylisothiazolin-3-one
2-Phenoxyethanol
Phenoxypropanol
o-Phenylphenol
Quaternary ammonium salts, for example N-alkyl-N,N-dimethylbenzylammonium chloride
Trimethylene-2-methylisothiazolinon-3-one
   and optionally further substances.

Frequently, further synergistic effects are observed here.

The use concentrations of the active ingredient formulations to be used in accordance with the invention depend upon the type and the occurrence of the microorganisms to be controlled, the initial microbial contamination and on the composition of the material to be protected. The optimal use amount for a particular application can be determined before use in practice by test series in a laboratory. In general, the use concentrations are in the range of 0.01 to 5% by weight, preferably of 0.05 to 1.0% by weight, of the inventive mixture, based on the material to be protected.

### EXAMPLE 1

104 g of 1,2-benzoisothiazolin-3-one (BIT) (79% strength) were slurried in 380 ml of demineralized water and admixed with 108 g of a 45% KOH solution. 600 g of a 70% solution of TMAD in water were added thereto. A further 309 g of water were added.

The clear solution had a pH of 10.9 and a content of BIT, measured by HPLC, of 5.7%. After storage at 40° C. for 5 months, the solution was clear. After storage at 20° C. for 5 months, the solution was clear and the content of 1,2-benzoisothiazolin-3-one was 5.4%.

### Example of a Comparative Formulation with Cosolvent and pH=9.5

18 g of 1,2-benzoisothiazolin-3-one (BIT) (84% strength) were slurried in 105 ml of demineralized water. Slow addition of 6.26 g of KOH pellets adjusted the pH to 9.5. 199 g of tetramethylolacetylenediurea (TMAD) (70% strength) and 45 g of propylene glycol were added to this virtually clear solution. Further addition of 0.6 g of KOH adjusted the pH to 9.5. This gave a clear solution with 4.86% BIT.

After storage at room temperature for one week, cloudiness of the solution was observed, and, after one week at 40° C., sediment.

1. Aqueous alkaline formulations having a pH of >10, comprising 1,2-benzoisothiazolin-3-one (BIT) and/or its alkali metal salts and tetramethylolacetylenediurea (TMAD).

2. Formulations according to claim 1, wherein the metal salts are sodium, potassium or lithium salts or mixtures thereof and characterized in that the weight ratio of 1,2-benzoisothiazolin-3-one (BIT) and/or its sodium, potassium or lithium salts or mixtures thereof to tetramethylolacetylenediurea (TMAD) is 9:1 to 1:9.

3. Formulations according to claim 1, wherein the metal salts are sodium, potassium or lithium salts or mixtures thereof and characterized in that the sum of the components 1,2-benzoisothiazolin-3-one (BIT) and/or its sodium, potassium or lithium salts or mixtures thereof and tetramethylolacetylenediurea (TMAD) is 5 to 80% by weight.

4. Formulations according to claim 1, characterized in that the pH is 10 to 14.

5. Formulations according to claim 1, characterized in that at least one cosolvent is present in an amount of 0 to 5% by weight based on the total weight of the formulation.

6. Formulations according to claim 1, characterized in that a free formaldehyde is present and the proportion of the free formaldehyde in the formulation is <1% by weight.

7. Process for preparing a formulation according to claim 1, comprising:
a) dissolving BIT and/or its sodium, potassium or lithium salt or mixtures thereof in water thereby forming a solution; and
b) mixing the solution with a solution of tetramethyloldiurea (TMAD) in water.

8. A process for protecting industrial materials and products from infection and destruction by microorganisms, comprising: contacting said industrial materials with the formulation according to claim 1.

9. The process according to claim 8, characterized in that the industrial materials to be protected are functional liquids and aqueous industrial products.

10. A method for protecting industrial materials from infection and destruction by microorganisms, comprising treating the industrial material with a formulation according to claim 1.

11. The process according to claim 7, wherein step a) is performed with the addition of sodium hydroxide, potassium hydroxide, lithium hydroxide or mixtures thereof.

12. The process according to claim 7, wherein step b) is performed with the addition of at least one cosolvent.

13. The process according to claim 7, further comprising step,
c) adjusting the pH of the overall formulation to a value of >10 by adding sodium hydroxide, potassium hydroxide, lithium hydroxide or mixtures thereof.
